(19) United States
(12) Patent Application Publication
(10) Pub. No.: US 2010/0255299 A1
(43) Pub. Date: Oct. 7, 2010

(54) METHOD OF APPLYING PRESSURE-SENSITIVE ADHESIVE SHEET FOR SEMICONDUCTOR WAFER PROTECTION AND PRESSURE-SENSITIVE ADHESIVE SHEET FOR SEMICONDUCTOR WAFER PROTECTION FOR USE IN THE APPLICATION METHOD

(75) Inventors: Noriyoshi KAWASHIMA, Osaka (JP); Fumiteru ASAI, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/752,403

(22) Filed: Apr. 1, 2010

(30) Foreign Application Priority Data
Apr. 2, 2009 (JP) 2009-090230

(51) Int. Cl. C09J 7/02; C09J 5/06

(52) U.S. Cl. 428/354; 156/322

(57) ABSTRACT

The present invention provides a method of applying a pressure-sensitive adhesive sheet for semiconductor wafer protection, the method including applying to a surface of a semiconductor wafer a pressure-sensitive adhesive sheet for semiconductor wafer protection including a substrate, at least one interlayer, and a pressure-sensitive adhesive layer superposed in this order, in which the pressure-sensitive adhesive sheet is applied to the semiconductor wafer at an application temperature in the range of from 50° C. to 100° C. and the interlayer in contact with the pressure-sensitive adhesive layer has a loss tangent (tan δ) of 0.5 or larger at the application temperature.

### FIELD OF THE INVENTION

The present invention relates to a method of applying a pressure-sensitive adhesive sheet for semiconductor wafer protection to a semiconductor wafer having surface irregularities, and also relates to a pressure-sensitive adhesive sheet for semiconductor wafer protection which is for use in the application method.

### BACKGROUND OF THE INVENTION

When a semiconductor wafer having surface irregularities attributable to structures such as bumps is subjected to back side grinding, it is necessary to protect the front side of the wafer in order to prevent the irregularities present on the wafer front side from being damaged and prevent the wafer front side from being contaminated with wafer grinding dust, grinding water, etc. There also is a problem that the ground wafer is apt to break even with a slight external force because the ground wafer itself is thin and brittle and because the wafer front side has surface irregularities.

A technique in which a pressure-sensitive adhesive tape is applied to the front side of a semiconductor wafer for that purpose, i.e., in order to protect the wafer front side and prevent wafer breakage during back side grinding of the wafer, has been known. For example, patent document 1 proposes a pressure-sensitive adhesive sheet employing a substrate which has a maximum value of loss tangent (tan δ) of 0.5 or larger at temperatures in the range of from −5 to 80° C. However, as a result of recent thickness reductions in semiconductor packages, there is an increasing trend toward semiconductor wafer grinding to a thickness which is not larger than the level difference of the irregularities formed on the front side of the wafer. Consequently, the performances required of such a pressure-sensitive adhesive sheet include conformability to irregularities during application to the front side of a wafer and suitability for conveyance, holding properties, etc. which are necessary after wafer back side grinding.

Patent Document 1: JP-A-11-343469

### SUMMARY OF THE INVENTION

An object of the invention is to provide a method of applying a pressure-sensitive adhesive sheet for semiconductor wafer protection which, when the back side of a wafer having irregularities formed on the front side thereof is ground to a thickness not larger than the level difference of the irregularities, is capable of protecting the irregularities of the wafer front side, preventing grinding dust, grinding water, and other substances from penetrating to the wafer front side, and preventing the ground wafer from breaking. Another object of the invention is to provide a pressure-sensitive adhesive sheet for semiconductor wafer protection which is for use in the application method.

Namely, the present invention provides a method of applying a pressure-sensitive adhesive sheet for semiconductor wafer protection, the method including applying to a surface of a semiconductor wafer a pressure-sensitive adhesive sheet for semiconductor wafer protection including a substrate, at least one interlayer, and a pressure-sensitive adhesive layer superposed in this order, in which the pressure-sensitive adhesive sheet is applied to the semiconductor wafer at an application temperature in the range of from 50° C. to 100° C. and the interlayer in contact with the pressure-sensitive adhesive layer has a loss tangent (tan δ) of 0.5 or larger at the application temperature.

The application temperature at which the pressure-sensitive adhesive sheet for semiconductor wafer protection (hereinafter referred to as pressure-sensitive adhesive sheet) is applied to a semiconductor wafer is from 50° C. to 100° C. The loss tangent (tan δ) of the interlayer in contact with the pressure-sensitive adhesive layer, at the application temperature, is 0.5 or larger, and preferably from 0.5 to 2.5. When the loss tangent (tan δ) of the interlayer in contact with the pressure-sensitive adhesive layer is in that range, the interlayer is soft at the temperature at which the pressure-sensitive adhesive sheet is applied to a semiconductor wafer. Consequently, this pressure-sensitive adhesive sheet, when applied to the front side of the wafer, satisfactorily conforms to the irregularities present on the wafer front side. Because of this, adhesion between the pressure-sensitive adhesive sheet and the semiconductor wafer is enhanced, whereby the irregularities present on the wafer front side can be prevented from being damaged during wafer back side grinding, and grinding dust and grinding water can be prevented from penetrating to the wafer front side during the wafer back side grinding.

According to the invention, the interlayer in contact with the pressure-sensitive adhesive layer (interlayer located on the side in contact with the pressure-sensitive adhesive layer) preferably has a loss modulus of from 0.005 MPa to 0.5 MPa at the application temperature.

The loss modulus of the interlayer in contact with the pressure-sensitive adhesive layer, at the application temperature, is preferably from 0.005 MPa to 0.5 MPa, more preferably from 0.01 MPa to 0.4 MPa, even more preferably from 0.015 MPa to 0.3 MPa. When the loss modulus of the interlayer in contact with the pressure-sensitive adhesive layer in the invention is within that range at the application temperature, the interlayer readily stretches and conforms to the wafer front-side irregularities when the pressure-sensitive adhesive sheet is applied to the front side of the wafer. Therefore, the pressure-sensitive adhesive sheet which has been applied to the front side of the wafer can be inhibited from lifting up from the front side of the wafer. Consequently, wafer breakage and the penetration of grinding dust or grinding water to the wafer front side can be prevented from occurring during the wafer back side grinding.

According to the invention, it is also preferred that the interlayer in contact with the pressure-sensitive adhesive layer have a storage modulus of 0.5 MPa or higher at 23° C.

The storage modulus of the interlayer in contact with the pressure-sensitive adhesive layer, at 23° C., is preferably 0.5 MPa or higher, more preferably from 0.7 MPa to 5 MPa, even more preferably from 0.8 MPa to 3 MPa. When the storage modulus of the interlayer in contact with the pressure-sensitive adhesive layer in the invention is within that range at 23° C., the interlayer in contact with the pressure-sensitive adhesive layer can be prevented from protruding due to a pressure applied to the pressure-sensitive adhesive sheet during the grinding of the wafer back side to be conducted after application of the pressure-sensitive adhesive sheet to the front side of the wafer. Consequently, the pressure-sensitive adhesive sheet can properly hold the wafer and the wafer can be thus inhibited from breaking during the wafer back side grinding.

According to the invention, it is further preferred that, when the pressure-sensitive adhesive sheet includes a plurality of interlayers, the thickness of the interlayer in contact with the pressure-sensitive adhesive layer account for at least 50% of the total thickness of the interlayers.

The thickness of the interlayer in contact with the pressure-sensitive adhesive layer accounts for preferably at least 50%, more preferably at least 55%, even more preferably at least 60%, of the total thickness of the interlayers. In the case where the thickness of the interlayer in contact with the pressure-sensitive adhesive layer is within that range, the pressure-sensitive adhesive sheet, when applied to the front side of a wafer, shows better conformability to the irregularities present on the front side of the wafer. In addition, since this interlayer functions as a buffer layer for buffering a pressure to be applied during the wafer back side grinding, the irregularities on the wafer front side can be inhibited from being damaged and the wafer can be inhibited from breaking.

According to the invention, it is preferred that the substrate be a polyester film.

From the standpoint of conveying the semiconductor wafer, which has become thin and brittle, after the back side grinding of the wafer, it is preferred to use a polyester film having high rigidity. When a polyester film is used as the substrate, this substrate can be inhibited from sticking to the chuck table after completion of the wafer back side grinding because the substrate has high rigidity and no tackiness.

According to the invention, the substrate preferably has a thickness of from 10 μm to 150 μm.

The thickness of the substrate is preferably from 10 μm to 150 μm, more preferably from 15 μm to 125 μm, even more preferably from 20 μm to 100 μm. In the case where the thickness of the substrate is within that range, the pressure-sensitive adhesive sheet has high shape stability after having been wound into a roll form. In case where the thickness of the substrate is smaller than 10 μm, this pressure-sensitive adhesive sheet is less apt to show satisfactory shape retentivity after having been wound into a roll form. In case where the thickness of the substrate is larger than 150 μm, the release sheet is apt to peel off after the pressure-sensitive adhesive sheet has been wound into a roll.

### BRIEF DESCRIPTION OF THE DRAWINGS

FIG. 1 is a diagrammatic view illustrating a pressure-sensitive adhesive sheet for semiconductor wafer protection according to the invention which has been applied to the front side of a semiconductor wafer.

FIG. 2 is a diagrammatic view illustrating another pressure-sensitive adhesive sheet for semiconductor wafer protection according to the invention which has been applied to the front side of a semiconductor wafer.

### DESCRIPTION OF REFERENCE NUMERALS AND SIGNS

1 Substrate
2 Interlayer
3 Pressure-sensitive adhesive layer
4 Pressure-sensitive adhesive sheet for semiconductor wafer protection
5 Circuit surface of semiconductor wafer
6 Semiconductor wafer

### DETAILED DESCRIPTION OF THE INVENTION

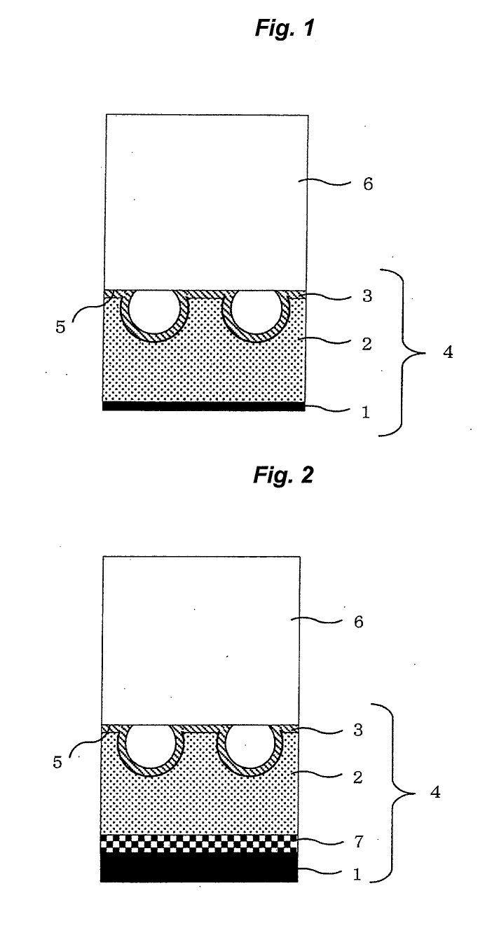

The pressure-sensitive adhesive sheet for semiconductor wafer protection to be used in the invention is explained below in detail while referring to the drawings according to need. FIG. 1 and FIG. 2 are diagrammatic views each illustrating a pressure-sensitive adhesive sheet for semiconductor wafer protection according to the invention which has been applied to the front side of a semiconductor wafer.

The pressure-sensitive adhesive sheet 4 for semiconductor wafer protection shown in FIG. 1 is a pressure-sensitive adhesive sheet applied to a circuit-bearing surface 5 of a semiconductor wafer 6, and is composed of a pressure-sensitive adhesive layer 3, an interlayer 2, and a substrate 1 which have been arranged in this order from the circuit-bearing surface 5 side.

The pressure-sensitive adhesive layer 3 may be constituted of a common pressure-sensitive adhesive. Examples thereof include copolymers of acrylic monomers (acrylic pressure-sensitive adhesives), silicone-type pressure-sensitive adhesives, and rubber-based pressure-sensitive adhesives. One pressure-sensitive adhesive or a mixture of two or more pressure-sensitive adhesives can be used.

It is especially preferred to use an acrylic pressure-sensitive adhesive as the pressure-sensitive adhesive layer 3. When the pressure-sensitive adhesive layer 3 is formed of an acrylic pressure-sensitive adhesive, this pressure-sensitive adhesive sheet, after grinding, can be stripped from the wafer surface while diminishing wafer surface contamination with the pressure-sensitive adhesive. The thickness of the pressure-sensitive adhesive layer 3 is preferably from 5 μm to 60 μm, more preferably from 10 μm to 55 μm, even more preferably from 15 μm to 50 μm. When the thickness of the pressure-sensitive adhesive layer 3 is within that range, the pressure-sensitive adhesive sheet has improved conformability to the irregularities of the circuit-bearing surface 5.

The polymer constituting the pressure-sensitive adhesive may have a crosslinked structure. Such a polymer is obtained by polymerizing a monomer mixture including a monomer having a functional group such as a carboxyl, hydroxyl, epoxy, or amino group (for example, an acrylic monomer) in the presence of a crosslinking agent. A pressure-sensitive adhesive sheet including a pressure-sensitive adhesive layer containing a polymer having a crosslinked structure has improved self-holding properties. This pressure-sensitive adhesive sheet can hence be prevented from deforming and can be kept in a flat state. Therefore, this pressure-sensitive adhesive sheet can be precisely and easily applied to a semiconductor wafer with, for example, an automatic applicator.

A pressure-sensitive adhesive of the ultraviolet-curable type can also be used as the pressure-sensitive adhesive. This pressure-sensitive adhesive is obtained, for example, by incorporating into a pressure-sensitive adhesive substance an oligomer ingredient which cures upon irradiation with ultraviolet to form a lowly adhesive substance. Use of a pressure-sensitive adhesive layer constituted of a pressure-sensitive adhesive of the ultraviolet-curable type has the following advantages. When the pressure-sensitive adhesive sheet is applied, the application is facilitated because the oligomer ingredient imparts plastic flowability to the pressure-sensitive adhesive. In addition, when the pressure-sensitive adhesive sheet is stripped off, ultraviolet irradiation yields a lowly adhesive substance and this facilitates stripping from the wafer.

Examples of major monomers for the pressure-sensitive adhesive include methyl acrylate, methyl methacrylate, ethyl acrylate, ethyl methacrylate, butyl acrylate, butyl methacrylate, 2-ethylhexyl acrylate, and 2-ethylhexyl methacrylate. These monomers may be used alone, or a mixture of two or more thereof may be used. With respect to the amount of such major monomers to be used, it is preferred that the major monomers be contained in an amount generally in the range of from 60% by weight to 99% by weight based on the total amount of all monomers used as raw materials for the pressure-sensitive adhesive polymer.

Examples of the comonomer, which has a functional group reactive with a crosslinking agent and is copolymerized with the major monomers, include acrylic acid, methacrylic acid, itaconic acid, mesaconic acid, citraconic acid, fumaric acid, maleic acid, monoalkyl esters of itaconic acid, monoalkyl esters of mesaconic acid, monoalkyl esters of citraconic acid, monoalkyl esters of fumaric acid, monoalkyl esters of maleic acid, 2-hydroxyethyl acrylate, 2-hydroxyethyl methacrylate, acrylamide, methacrylamide, tert-butylaminoethyl acrylate, and tert-butylaminoethyl methacrylate. One of these may be copolymerized with the major monomers, or two or more thereof may be copolymerized. With respect to the amount of the comonomer to be used, which has a functional group reactive with a crosslinking agent, it is preferred that the comonomer be contained in an amount generally in the range of from 1% by weight to 40% by weight based on the total amount of all monomers used as raw materials for the pressure-sensitive adhesive polymer.

It is preferred that the interlayer 2 contain at least a thermoplastic resin from the standpoints of wafer-holding properties, releasability from wafers, the property of not contaminating wafer surfaces, etc. One thermoplastic resin may be contained, or two or more thermoplastic resins may be used in combination.

Typical examples of the thermoplastic resin include polyethylene (PE); polybutene; ethylene copolymers such as ethylene/propylene copolymers (EPM), ethylene/propylene/diene copolymers (EPDM), ethylene/ethyl acrylate copolymers (EEA), ethylene/ethyl acrylate/maleic anhydride copolymers (EEAMAH), ethylene/glycidyl methacrylate copolymers (EGMA), ethylene/methacrylic acid copolymers (EMAA), and ethylene/vinyl acetate copolymers (EVA); polyolefin copolymers; thermoplastic elastomers such as butadiene-based elastomers, ethylene/isoprene elastomers, and ester-based elastomers; thermoplastic polyesters; polyamide resins such as polyamide-12; polyurethanes; polystyrene resins; cellophane; acrylic resins such as poly(acrylic ester)s and poly(methyl methacrylate); and poly(vinyl chloride) resins such as vinyl chloride/vinyl acetate copolymers.

The thermoplastic resin has a weight-average molecular weight in the range of preferably from 20,000 to 300,000, more preferably from 30,000 to 250,000.

The interlayer 2 may contain other ingredients so long as the incorporation thereof does not impair properties. Examples of such ingredients include tackifiers, plasticizers, softeners, fillers, and antioxidants. Although the pressure-sensitive adhesive sheet may include single interlayer, it may include a plurality of interlayers of the same or different kinds.

Examples of the material constituting the substrate 1 include polyesters such as poly(ethylene terephthalate) (PET) and poly(ethylene naphthalate) (PEN). One of such materials or a combination of two or more thereof can be used as the substrate 1. The substrate 1 may have a multilayer structure composed of a plurality of layers of the same or different kinds.

As the substrate 1, it is especially preferred to use a polyester film having high rigidity from the standpoint of conveying the semiconductor wafer, which has become thin and brittle, after the back side grinding of the wafer. When a polyester film is used as the substrate, this substrate can be inhibited from sticking to the chuck table after completion of the wafer back side grinding because the substrate has high rigidity and no tackiness.

The pressure-sensitive adhesive sheet 4 for semiconductor wafer protection of the invention is produced by producing a laminate of a substrate 1 with an interlayer 2 and then forming a pressure-sensitive adhesive layer 3 on the interlayer-2-side surface of the laminate. Examples of methods for forming the laminate of a substrate 1 with an interlayer 2 include: a method in which an interlayer 2 in a film form is produced by extrusion molding with an extruder and is laminated, simultaneously with the extrusion molding, to a substrate 1 which has been prepared beforehand; and a method in which a substrate 1 and an interlayer 2 are coextruded. Examples of coextrusion techniques include the T-die extrusion method and the inflation method. Examples of methods for forming a pressure-sensitive adhesive layer 3 on the surface on the interlayer 2 side include: a method in which a pressure-sensitive adhesive composition is applied to one surface of a release film and dried to form a pressure-sensitive adhesive layer 3 and the pressure-sensitive adhesive layer 3 obtained is then transferred to the interlayer-2-side surface of the laminate; and a method in which a pressure-sensitive adhesive composition is applied to the interlayer-2-side surface of the laminate and dried to form a pressure-sensitive adhesive layer 3.

For the purpose of enhancing the force of adhesion between the substrate 1 and the interlayer 2, an adhesive layer may be newly disposed therebetween. It is preferred that the side of the interlayer 2 to which a pressure-sensitive adhesive layer 3 is to be formed be subjected to a corona treatment, chemical treatment, etc. in order to enhance the force of adhesion between the interlayer 2 and the pressure-sensitive adhesive layer 3. Furthermore, an undercoat layer may be disposed between the interlayer 2 and the pressure-sensitive adhesive layer 3.

The pressure-sensitive adhesive sheet 4 for semiconductor wafer protection of the invention may be folded by an accordion fold, or may be wound into a roll form.

The pressure-sensitive adhesive sheet 4 for semiconductor wafer protection of the invention is suitable for use in the back side grinding of a semiconductor wafer having projections with a height of from 100 μm to 300 μm on the front side thereof.

A release film can be disposed on the pressure-sensitive adhesive layer 3 for the purpose of protecting the pressure-sensitive adhesive layer 3. Examples of the release film include plastic films (e.g., poly(ethylene terephthalate), polypropylene, and polyethylene) or sheets of paper which have undergone a silicone treatment or fluorochemical treatment and nonpolar materials (in particular, nonpolar polymers) such as polyethylene and polypropylene.

The pressure-sensitive adhesive sheet 4 for semiconductor wafer protection shown in FIG. 2 as another embodiment of the invention is a pressure-sensitive adhesive sheet applied to a circuit-bearing surface 5 of a semiconductor wafer 6, and is composed of a pressure-sensitive adhesive layer 3, an interlayer 2, a second interlayer 7, and a substrate 1 which have been arranged in this order from the circuit-bearing surface 5 side.

The second interlayer 7, which is disposed between the substrate 1 and the interlayer 2, serves to unite the substrate 1 with the interlayer 2. Examples of the material constituting the second interlayer 7 include low-density polyethylene resins (LDPE).

### EXAMPLES

The invention will be explained below in more detail by reference to Examples, but the invention should not be construed as being limited by the following Examples.

### Example 1

Poly(ethylene terephthalate) was used as a resin for a substrate and an ethylene/vinyl acetate copolymer resin A (EVA) was used as a thermoplastic resin for an interlayer, respectively, to produce a laminate of a substrate (thickness: 38 μm) with an interlayer (thickness: 450 μm) by a laminating method. Subsequently, that surface of the interlayer on which a pressure-sensitive adhesive layer was to be formed was subjected to a corona treatment, and a pressure-sensitive adhesive layer A (thickness: 30 μm) was transferred to the corona-treated surface of the interlayer. After the transfer, the resultant multilayer structure was heated at 45° C. for 24 hours and then cooled to room temperature to thereby obtain a pressure-sensitive adhesive sheet for semiconductor wafer protection. Thereafter, this pressure-sensitive adhesive sheet was heated to 65° C. and applied to the front side of each of semiconductor wafers. The pressure-sensitive adhesive sheet applied was examined for voids. Subsequently, the semiconductor wafers were subjected to back side grinding. As a result, the number of wafers which had broken was 0 in 10. The number of wafers which had suffered grinding water penetration was 0 in 10. The interlayer had a tan δ of 0.64 and a loss modulus of 0.02 MPa at 65° C. The interlayer had a storage modulus of 1.5 MPa at 23° C.

### Example 2

Poly(ethylene terephthalate) was used as a resin for a substrate and an ethylene/vinyl acetate copolymer resin A (EVA) was used as a thermoplastic resin for an interlayer, respectively, to produce a laminate of a substrate (thickness: 50 μm) with an interlayer (thickness: 390 μm) by a laminating method. Subsequently, that surface of the interlayer on which a pressure-sensitive adhesive layer was to be formed was subjected to a corona treatment, and a pressure-sensitive adhesive layer A (thickness: 40 μm) was transferred to the corona-treated surface of the interlayer. After the transfer, the resultant multilayer structure was heated at 45° C. for 24 hours and then cooled to room temperature to thereby obtain a pressure-sensitive adhesive sheet for semiconductor wafer protection. Thereafter, this pressure-sensitive adhesive sheet was heated to 60° C. and applied to the front side of each of semiconductor wafers. The pressure-sensitive adhesive sheet applied was examined for voids. Subsequently, the semiconductor wafers were subjected to back side grinding. As a result, the number of wafers which had broken was 0 in 10. The number of wafers which had suffered grinding water penetration was 0 in 10. The interlayer had a tan δ of 0.54 and a loss modulus of 0.07 MPa at 60° C. The interlayer had a storage modulus of 1.5 MPa at 23° C.

### Example 3

Poly(ethylene terephthalate) was used as a resin for a substrate and an ethylene/propylene/diene resin (EPDM) was used as a thermoplastic resin for an interlayer, respectively, to produce a laminate of a substrate (thickness: 38 μm) with an interlayer (thickness 450 μm) by a laminating method. Subsequently, that surface of the interlayer on which a pressure-sensitive adhesive layer was to be formed was subjected to a corona treatment, and a pressure-sensitive adhesive layer A (thickness: 40 μm) was transferred to the corona-treated surface of the interlayer. After the transfer, the resultant multilayer structure was heated at 45° C. for 24 hours and then cooled to room temperature to thereby obtain a pressure-sensitive adhesive sheet for semiconductor wafer protection. Thereafter, this pressure-sensitive adhesive sheet was heated to 50° C. and applied to the front side of each of semiconductor wafers. The pressure-sensitive adhesive sheet applied was examined for voids. Subsequently, the semiconductor wafers were subjected to back side grinding. As a result, the number of wafers which had broken was 0 in 10. The number of wafers which had suffered grinding water penetration was 0 in 10. The interlayer had a tan δ of 1.6 and a loss modulus of 0.03 MPa at 50° C. The interlayer had a storage modulus of 0.90 MPa at 23° C.

### Example 4

Poly(ethylene terephthalate) was used as a resin for a substrate and polyethylene (PE) was used as a thermoplastic resin for an interlayer, respectively, to produce a laminate of a substrate (thickness: 38 μm) with an interlayer (thickness: 450 μm) by a laminating method. Subsequently, that surface of the interlayer on which a pressure-sensitive adhesive layer was to be formed was subjected to a corona treatment, and a pressure-sensitive adhesive layer A (thickness: 40 μm) was transferred to the corona-treated surface of the interlayer. After the transfer, the resultant multilayer structure was heated at 45° C. for 24 hours and then cooled to room temperature to thereby obtain a pressure-sensitive adhesive sheet for semiconductor wafer protection. Thereafter, this pressure-sensitive adhesive sheet was heated to 80° C. and applied to the front side of each of semiconductor wafers. The pressure-sensitive adhesive sheet applied was examined for voids. Subsequently, the semiconductor wafers were subjected to back side grinding. As a result, the number of wafers which had broken was 0 in 10. The number of wafers which had suffered grinding water penetration was 0 in 10. The interlayer had a tan δ of 0.58 and a loss modulus of 0.07 MPa at 80° C. The interlayer had a storage modulus of 2.8 MPa at 23° C.

### Example 5

Poly(ethylene terephthalate) was used as a resin for a substrate, and a low-density polyethylene resin (LDPE) was used as a material for a second interlayer. Furthermore, an ethylene/vinyl acetate copolymer resin (EVA) was used as a thermoplastic resin for an interlayer. An anchor coating material was applied to one side of the substrate and dried, and the low-density polyethylene resin was melt-extruded and laminated to the anchor-coated side. Thereafter, the ethylene/vinyl acetate copolymer resin was extruded and applied to the low-density polyethylene layer to thereby produce a laminate composed of the substrate (thickness: 50 μm), a second interlayer (thickness: 15 μm), and an interlayer (thickness: 450 μm). Subsequently, that surface of the interlayer on which a pressure-sensitive adhesive layer was to be formed was subjected to a corona treatment, and a pressure-sensitive adhesive layer A (thickness: 30 μm) was transferred to the corona-treated surface of the interlayer. After the transfer, the resultant multilayer structure was heated at 45° C. for 24 hours and then cooled to room temperature to thereby obtain a pressure-sensitive adhesive sheet for semiconductor wafer protection. Thereafter, this pressure-sensitive adhesive sheet was heated to 65° C. and applied to the front side of each of semiconductor wafers. The pressure-sensitive adhesive sheet applied was examined for voids. Subsequently, the semiconductor wafers were subjected to back side grinding. As a result, the number of wafers which had broken was 0 in 10. The number of wafers which had suffered grinding water penetration was 0 in 10. The interlayer had a tan δ of 0.64 and a loss modulus of 0.02 MPa at 65° C. The interlayer had a storage modulus of 1.5 MPa at 23° C.

### Comparative Example 1

A pressure-sensitive adhesive sheet was produced in the same manner as in Example 1, except that the thickness of the substrate was changed to 50 μm and the thickness of the pressure-sensitive adhesive layer A was changed to 40 μm. Thereafter, this pressure-sensitive adhesive sheet was heated to 40° C. and applied to the front side of each of semiconductor wafers. The pressure-sensitive adhesive sheet applied was examined for voids. Subsequently, the semiconductor wafers were subjected to back side grinding. As a result, the number of wafers which had broken was 10 in 10. The number of wafers which had suffered grinding water penetration was 10 in 10. The interlayer had a tan δ of 0.3 and a loss modulus of 0.15 MPa at 40° C. The interlayer had a storage modulus of 1.5 MPa at 23° C.

### Comparative Example 2

A pressure-sensitive adhesive sheet was produced in the same manner as in Example 1, except that the thickness of the interlayer was changed to 420 μm. Thereafter, this pressure-sensitive adhesive sheet was heated to 70° C. and applied to the front side of each of semiconductor wafers. The pressure-sensitive adhesive sheet applied was examined for voids. Subsequently, the semiconductor wafers were subjected to back side grinding. As a result, the number of wafers which had broken was 7 in 10, and many cracks were observed in the outer periphery of each wafer. The number of wafers which had suffered grinding water penetration was 7 in 10. The interlayer had a tan δ of 0.45 and a loss modulus of 0.07 MPa at 70° C. The interlayer had a storage modulus of 1.5 MPa at 23° C.

### Comparative Example 3

A solventless resin layer (thickness: 400 μm) was used as an interlayer, and a pressure-sensitive adhesive layer A (thickness: 30 μm) was transferred to the solventless resin layer B. After the transfer, the resultant multilayer structure was heated at 45° C. for 24 hours and then cooled to room temperature to thereby obtain a pressure-sensitive adhesive sheet for semiconductor wafer protection. Thereafter, this pressure-sensitive adhesive sheet was heated to 23° C. and applied to the front side of each of semiconductor wafers. The pressure-sensitive adhesive sheet applied was examined for voids. Subsequently, the semiconductor wafers were subjected to back side grinding. As a result, the number of wafers which had broken was 9 in 10. Of the nine wafers, seven broke during conveyance thereof and two broke due to a vacuum holding error on the wafer back grinder. The number of wafers which had suffered grinding water penetration was 0 in 10. The interlayer had a tan δ of 0.8 and a loss modulus of 0.14 MPa at 23° C. The interlayer had a storage modulus of 1.9 MPa at 23° C.

Methods of Determining Loss Modulus, Storage Modulus, and Loss Tangent (tan δ)

A disk having a diameter of 7.9 mm was punched out of a test sample of an interlayer (thickness: 2 mm; the sample had undergone autoclave treatment for degassing). The disk was sandwiched between parallel plates and examined with viscoelastometer ARES, manufactured by Rheometric Inc. In the examination, the temperature of the sample was changed from −5° C. to 75° C. at a heating rate of 5° C./min while applying shearing strain thereto at a frequency of 1 Hz, and values of loss modulus G″ and storage modulus G′ were obtained at each temperature. Loss tangent tan δ was calculated using the following equation.

Loss tangent tan δ=(loss modulus G″)/(storage modulus G′)

Semiconductor Wafers

The semiconductor wafers used in the Examples and Comparative Examples were ones each obtained by forming solder bumps with the following height at the following pitch on a surface of an 8-inch wafer (thickness, 750 μm).

Height of solder bumps: 200 μm

Pitch of solder bumps: 400 μm

Method of Applying Pressure-Sensitive Adhesive Sheet to Wafer Surface

DR-3000 III, manufactured by Nitto Seiki Inc., was used to apply a pressure-sensitive adhesive sheet at a given application temperature and a speed not higher than 10 mm/sec while applying a given pressure of 0.2 MPa or higher.

Method of Grinding Wafer Back Side

After a pressure-sensitive adhesive sheet had been applied to the front side of a wafer, the back side of the wafer was ground to a thickness of 180 μm with a silicon wafer grinder manufactured by Disco Corp.

Method of Preparing Pressure-Sensitive Adhesive Layer A

A mixture composed of 78 parts by weight of ethyl acrylate, 100 parts by weight of butyl acrylate, and 40 parts by weight of 2-hydroxyethyl acrylate was copolymerized in a toluene solution to obtain an acrylic copolymer having a weight-average molecular weight of 300,000. Subsequently, 43 parts by weight of 2-methacryloyloxyethyl isocyanate was subjected to addition reaction with the acrylic copolymer to incorporate carbon-carbon double bonds into side chains of the polymer molecule. A hundred parts by weight of this polymer was mixed with 0.1 part by weight of a polyisocyanate crosslinking agent and 10 parts by weight of an acetophenone compound photopolymerization initiator. The resultant mixture was applied to a releasant-treated PET film in a thickness of 30 μm or 40 μm on a dry basis to thereby prepare a pressure-sensitive adhesive layer A.

Method of Preparing Solventless Resin Layer

Into a reaction vessel equipped with a condenser, thermometer, and stirrer were introduced 100 parts by weight of 2-ethylhexyl acrylate and 10 parts by weight of acrylic acid as acrylic monomers and 0.35 parts by weight of 1-hydroxycyclohexyl phenyl ketone (registered trademark “Irgacure 184”, manufactured by Ciba Specialty Chemicals Co.) and 0.35 parts by weight of 2,2-dimethoxy-1,2-diphenylethan-1-one (registered trademark “Irgacure 651”, manufactured by Ciba Specialty Chemicals Co.) as photopolymerization initiators. The reaction mixture was exposed to ultraviolet in a nitrogen atmosphere to partly polymerize the monomers and thereby increase the viscosity of the mixture. Thus, a syrup containing a prepolymer was produced. To this syrup was added 0.2 parts by weight of trimethylolpropane triacrylate as a polyfunctional monomer. The resultant mixture was stirred and then applied to a releasant-treated PET film (thickness: 38 μm) in such an amount as to give a cured layer having a thickness of 400 μm. A releasant-treated PET film (thickness: 38 μm) was superposed as a separator thereon to cover the syrup layer. Subsequently, the syrup layer was irradiated from the side of this PET film with ultraviolet (irradiance: 170 mW/cm²; quantity of light: 2,500 mJ/cm²) using a high-pressure mercury lamp to thereby cure the layer. The cured layer from which both of the releasant-treated PET films had been removed was used as a solventless resin layer.

Method of Examination for Voids

After a pressure-sensitive adhesive sheet was applied to the front side of a semiconductor wafer, the pressure-sensitive adhesive sheet was examined with a digital microscope (50 magnifications) for voids around solder bumps. The pressure-sensitive adhesive sheets which had voids around solder bumps are indicated by “observed”, and those which had no voids are indicated by “not observed”.

Percentage of Semiconductor Wafer Breakage (%)

After semiconductor wafer back grinding, the wafers were examined for breakage or cracks either visually or with a digital microscope (50 magnifications). From the number of semiconductor wafers which had broken as a result of the grinding of ten wafers, the percentage of semiconductor wafer breakage was calculated using the following equation.

Percentage of semiconductor wafer breakage (%)={(number of broken wafers)/(number of ground wafers)}×100

Percentage Occurrence of Grinding Water Penetration

After semiconductor wafer back grinding, the semiconductor wafers were examined with a digital microscope (50 magnifications) for the penetration of the grinding water to the front side of the wafer. From the number of semiconductor wafers in which grinding water penetration had occurred as a result of the grinding of ten wafers, the percentage occurrence of grinding water penetration was calculated using the following equation.

Percentage occurrence of grinding water penetration (%)={(number of wafers to which grinding water penetrated)/(number of ground wafers)}×100

The results obtained in Examples 1 to 5 and Comparative Examples 1 to 3 are summarized in Table 1 and Table 2.

TABLE 1

| | | | | | | | Pressure- |
|---|---|---|---|---|---|---|---|
| | | | | | | | sensitive |
| | | | | | | | adhesive |
| | Substrate | | Second interlayer | | Interlayer | | layer |
| | | Thickness | | Thickness | | Thickness | Thickness |
| | Material | (μm) | Material | (μm) | Material | (μm) | (μm) |
| Example 1 | PET | 38 | — | — | EVA | 450 | 30 |
| Example 2 | PET | 50 | — | — | EVA | 390 | 40 |
| Example 3 | PET | 38 | — | — | EPDM | 450 | 40 |
| Example 4 | PET | 38 | — | — | PE | 450 | 40 |
| Example 5 | PET | 50 | LDPE | 15 | EVA | 450 | 30 |
| Comparative | PET | 50 | — | — | EVA | 450 | 40 |
| Example 1 | | | | | | | |
| Comparative | PET | 38 | — | — | EVA | 420 | 30 |
| Example 2 | | | | | | | |
| Comparative | — | — | — | — | solvent- | 400 | 30 |
| Example 3 | | | | | less | | |
| | | | | | resin | | |

TABLE 2

| | | Interlayer | | | | | Percentage |
|---|---|---|---|---|---|---|---|
| | | | | Storage | | | occurrence |
| | Application | | Loss | modulus | | Percentage | of grinding |
| | temperature | | modulus | at 23° C. | | of wafer | water |
| | (° C.) | tanδ | (MPa) | (MPa) | Voids | breakage | penetration |
| Example 1 | 65 | 0.64 | 0.02 | 1.5 | not | 0% | 0% |
| | | | | | observed | | |
| Example 2 | 60 | 0.54 | 0.07 | 1.5 | not | 0% | 0% |
| | | | | | observed | | |
| Example 3 | 50 | 1.6 | 0.03 | 0.90 | not | 0% | 0% |
| | | | | | observed | | |
| Example 4 | 80 | 0.58 | 0.07 | 2.8 | not | 0% | 0% |
| | | | | | observed | | |
| Example 5 | 65 | 0.64 | 0.02 | 1.5 | not | 0% | 0% |
| | | | | | observed | | |
| Comparative | 40 | 0.3 | 0.15 | 1.5 | observed | 100% | 100% |
| Example 1 | | | | | | | |
| Comparative | 70 | 0.45 | 0.07 | 1.5 | not | 70% | 70% |
| Example 2 | | | | | observed | | |
| Comparative | 23 | 0.8 | 0.14 | 1.9 | observed | 90% | 0% |
| Example 3 | | | | | | | |

As shown in Table 1 and Table 2, the pressure-sensitive adhesive sheets of Examples 1 to 5 each were able to be applied to a semiconductor wafer without leaving voids around the solder bumps present on the front side of the wafer, because each pressure-sensitive adhesive sheet was applied to the semiconductor wafer at the application temperature in the range of from 50° C. to 100° C. and the interlayer in contact with the pressure-sensitive adhesive layer had a loss tangent (tan δ) of 0.5 or larger at the application temperature. Therefore, even after the grinding of the semiconductor wafer back sides, both the percentage of semiconductor wafer breakage and the percentage occurrence of grinding water penetration were 0%. In contrast, in the case of the pressure-sensitive adhesive sheet of Comparative Example 1, voids were observed after application of the pressure-sensitive adhesive sheet to the front side of each semiconductor wafer because the application temperature was lower than 50° C. and the loss tangent (tan δ) at the application temperature was smaller than 0.5. Although the pressure-sensitive adhesive sheet of Comparative Example 2 was applied at a temperature in the range of from 50° C. to 100° C., since the interlayer thereof in contact with the pressure-sensitive adhesive layer had a loss tangent (tan δ) of smaller than 0.5 at the application temperature, wafer cracking occurred during the back side grinding of the semiconductor wafers and semiconductor wafer breakage and grinding water penetration occurred. In the case of the pressure-sensitive adhesive sheet of Comparative Example 3, application thereof to the front side of each wafer resulted in voids because the application temperature was not within the range of from 50° C. to 100° C. and the pressure-sensitive adhesive sheet hence was not sufficiently heated, although the interlayer in contact with the pressure-sensitive adhesive layer had a loss tangent (tan δ) of 0.5 or larger at the application temperature. In addition, since this pressure-sensitive adhesive sheet had no substrate, this pressure-sensitive adhesive sheet did not have rigidity which enabled the pressure-sensitive adhesive sheet to withstand conveyance after the back side grinding of the semiconductor wafers. Furthermore, an error in vacuum holding on the chuck table occurred and this increased the percentage of semiconductor wafer breakage.

While the present invention has been described in detail and with reference to specific embodiments thereof, it will be apparent to one skilled in the art that various changes and modifications can be made therein without departing from the scope thereof.

This application is based on Japanese patent application No. 2009-090230 filed Apr. 2, 2009, the entire contents thereof being hereby incorporated by reference.

What is claimed is:

1. A method of applying a pressure-sensitive adhesive sheet for semiconductor wafer protection, the method comprising applying to a surface of a semiconductor wafer a pressure-sensitive adhesive sheet for semiconductor wafer protection comprising a substrate, at least one interlayer, and a pressure-sensitive adhesive layer superposed in this order, wherein the pressure-sensitive adhesive sheet is applied to the semiconductor wafer at an application temperature in the range of from 50° C. to 100° C. and the interlayer in contact with the pressure-sensitive adhesive layer has a loss tangent (tan δ) of 0.5 or larger at the application temperature.

2. The method of applying a pressure-sensitive adhesive sheet for semiconductor wafer protection according to claim 1, wherein the interlayer in contact with the pressure-sensitive adhesive layer has a loss modulus of from 0.005 MPa to 0.5 MPa at the application temperature.

3. The method of applying a pressure-sensitive adhesive sheet for semiconductor wafer protection according to claim 1, wherein the interlayer in contact with the pressure-sensitive adhesive layer has a storage modulus of 0.5 MPa or higher at 23° C.

4. The method of applying a pressure-sensitive adhesive sheet for semiconductor wafer protection according to claim 1, wherein the pressure-sensitive adhesive sheet comprises a plurality of interlayers, and the interlayer in contact with the pressure-sensitive adhesive layer has a thickness which accounts for at least 50% of the total thickness of said interlayers.

5. The method of applying a pressure-sensitive adhesive sheet for semiconductor wafer protection according to claim 1, wherein the substrate is a polyester film.

6. A pressure-sensitive adhesive sheet for semiconductor wafer protection which is for use in the method according to claim 1.
